(19) United States
(12) Patent Application Publication
(10) Pub. No.: US 2009/0039574 A1
(43) Pub. Date: Feb. 12, 2009

(54) Spring assembly

(76) Inventor: Paul William Cook, GB-Mountsorrel (GB)

Correspondence Address: HARNESS, DICKEY & PIERCE, P.L.C., P.O. BOX 8910, RESTON, VA, 20195, US

(21) Appl. No.: 11/976,010

(22) Filed: Oct. 19, 2007

Related U.S. Application Data
(60) Provisional application No. 60/935,396, filed on Aug. 10, 2007.

(51) Int. Cl. B61F 5/10; F16F 9/04

(52) U.S. Cl. 267/3; 267/64.27

(57) ABSTRACT

A spring assembly has a first end member, a second end member spaced from the first end member, and an elastomeric body between the end members. The elastomeric body is configured to be compressed in a main load direction which coincides with a centre axis of the spring assembly. Further the elastomeric body has an internal cavity which is symmetric about the centre axis and extends at least partially between the end members. The elastomeric body also has interleaving elements and stopping element configured to mechanically limit compression of the elastomeric body in the main load direction.

### PRIORITY STATEMENT

This application claims the benefit of priority under 35 U.S.C. §119(e) from U.S. Provisional Patent Application No. 60/035,396, filed on Aug. 10, 2007, in the U.S. Patent and Trademark Office, the disclosure of which is incorporated herein in its entirety by reference.

### BACKGROUND ART

Spring assemblies designed to withstand compression loads are used in a wide range of applications, such as railway carriages, heavy duty vehicles and other applications where damping or shock absorbing is essential. In general, such spring assemblies include an elastomeric body positioned between a pair of rigid end plates. The elastomeric body is made of rubber and is compressed by the load applied to the spring assembly. In many cases, these spring assemblies are used in combination with an air bellow/diaphragm, to achieve the desired characteristics needed for the application in question.

A problem with prior-art elastomeric spring assemblies of this kind is that they are hard to realize because the space available at the top of the spring assembly is often limited by an air bellow to approximately halfway down the elastomeric body, when the spring assembly is used in combination with an air bellow. To achieve a reduced diameter at the top half, an interleaving element are necessary to prevent overloading of the rubber and to maintain the vertical non-linear stiffness characteristic.

The space envelope available, when the spring assembly is used in combination with an air bellow, makes it difficult to control the compression of the elastomeric spring without having to adapt the surrounding parts. The space envelope of the top part of the spring assembly is essentially restricted by the air bellow. Also the design of the surrounding parts may restrict the space envelope significantly.

Previous designs of non-linear springs having approximately constant natural frequency can not be designed to achieve the space envelope restrictions when used in combination with an air bellow. This means that a larger air bellow/diaphragm would be needed in order to avoid contact between the spring assembly and the air bellow during horizontal and transversal loads. Furthermore the horizontal stiffness can only be controlled by adjusting the aspect ratio between the inner and outer profiles of the elastomeric body or by altering the number of elastomeric layers.

### SUMMARY

In view of the above, example embodiments provide a new spring assembly which is improved over prior-art spring assemblies and which solves or at least reduces the problems discussed above.

Example embodiments may provide a spring assembly which comprises:
a first end member;
a second end member spaced from said first end member;
an elastomeric body arranged between said first end member and said second end member,
   said elastomeric body being configured to be compressed in a main load direction which coincides with a centre axis of said spring assembly,
   said elastomeric body comprising an internal cavity which is symmetric about said centre axis and extends at least partially between said first end member and said second end member,
   said elastomeric body further comprising interleaving elements or means; and
a stopping element or means configured to mechanically limit compression of said elastomeric body in said main load direction.

A specific problem to be solved may be to provide an improved spring assembly for a secondary rail suspension air spring. A stopping element or means may be useful in order to keep a rail-mounted vehicle within its kinematic envelope. Therefore, an external stopping element or means were needed in previous designs. In example embodiments, a stopping element or means is provided integral to the design.

The required vertical stiffness is very low with a high load capacity. The use of interleaving elements restricts the elastomeric body to maintain a smaller diameter, whilst maintaining the near constant natural frequency requirement for vertical stiffness. This is advantageous in that a smaller air bellow/diaphragm can be used when the spring assembly is used with air bellow element or means. The improved design in general allows a lower horizontal to vertical stiffness ratio whilst maintaining the progressive nature of the vertical stiffness curve.

In example embodiments, the stopping element or means of the spring assembly comprises a protuberance which projects from said first end member and is located within said elastomeric body, which is advantageous in that integral stopping element or means can be realized without altering the external dimensions of the spring assembly.

In example embodiments, the stopping element or means comprises a protuberance which projects from said second end member and is located within the internal cavity of the elastomeric body.

In example embodiments, the stopping element or means comprises a first protuberance which projects from the first end member and is located within the elastomeric body, and a second protuberance which projects from the second end member and is located within the internal cavity.

In example embodiments, the stopping element or means is at least partly enclosed by elastomeric material of said elastomeric body, which is advantageous in that it provides the ability to tune the horizontal stiffness characteristics by providing a second higher rate stiffness after the initial deflection.

In example embodiments, the interleaving element or means comprises at least two annular interleaving elements which concentrically arranged about the centre axis in axially spaced positions. This provides favourable reinforcing effects, and provides the spring assembly with symmetric characteristics.

In example embodiments, the interleaving elements are made of substantially rigid material, for instance metal such as steel, which is favourable in that the elements are easily manufactured by casting, turning, milling, pressing, spinning or laser cutting.

In example embodiments, at least one of said interleaving elements has a conical cross-section. This results in lower material stress and that the fatigue endurance of the interleaving elements and the elastomeric body, the vertical stiffness is improved simultaneously.

The interleaving elements may be at least partially or predominantly embedded in the elastomeric body. This means that the interleaving elements are exposed to lower material stresses and that the vertical to horizontal stiffness ratio is lowered.

In example embodiments, the elastomeric body has a cross-section which is symmetric about the centre axis, which is advantageous in that it is easily manufactured and shows uniform stiffness characteristics in different directions.

In example embodiments, the elastomeric body has a general frustoconical cross-section, which is advantageous in that the spring assembly can be easily fitted to air bellow element or means with a small diameter air bellow/diaphragm, without having to adapt the air bellow or the air spring.

The elastomeric body may consist of rubber, for instance polyisoprene, which means that low dynamic stiffness together with low creep is achieved in the elastomeric body.

In example embodiments, the internal cavity of the elastomeric body opens towards the second end member, which is favourable in that the vertical and horizontal characteristics can be tuned by adjusting the shape of the internal cavity.

In example embodiments, the elastomeric body is bonded to the end members.

In example embodiments, the elastomeric body is bonded to the end members by vulcanization, which is favourable in that a strong and durable bond is established between the elastomeric body and the end members.

Alternatively, the elastomeric body is cold-bonded to the end members by means of an adhesive, which is advantageous in that the bonding can take place without heating the spring assembly.

In example embodiments, the spring assembly further comprises air bellow element or means configured to be compressed in at least the main load direction.

The air bellow element or means may be attached to one of the end members, which means that the air bellow element or means can take up different frequencies and therefore enhances the damping characteristics of the spring assembly.

In example embodiments of the spring assembly, one of the end members supporting the air bellow element or means is provided with a circumferential sealing area for an annular bellow of said air bellow element or means. This means that the air bellow can be fitted to the spring assembly without having to modify the spring assembly.

In example embodiments, one of the end members is provided with an air through passage. This means that air can be fed through the spring assembly to, for example, an air bellow.

Example embodiments provide a spring arrangement, a suspension system, a vibration anti-shock mounting system and a vehicle as defined in the appended claims.

### BRIEF DESCRIPTION OF THE DRAWINGS

In the following, example embodiments will be further described with reference to the appended drawings which illustrate embodiments, given as non-limiting examples, and in which:

FIG. 1 is a partial cross-sectional view of a spring assembly in accordance with example embodiments,

FIG. 2 is an end view of the spring assembly shown in FIG. 1,

FIG. 3 is a perspective view of the spring assembly of FIGS. 1-2,

FIG. 4 is a cross-sectional view of the spring assembly of FIGS. 1-3 in an operative mode in combination with an air bellow,

FIGS. 5-6 are schematic views of two load situations of the spring assembly of FIG. 4,

FIG. 7 is a perspective view of the spring assembly in combination with the air bellow shown in FIGS. 4-6,

FIG. 8 is a partial cross-sectional view of a spring assembly in accordance with example embodiments,

FIG. 9 is a partial cross-sectional view of a spring assembly in accordance with example embodiments,

FIG. 10 is a partial cross-sectional view of a spring assembly in accordance with example embodiments in which one interleaving element is conical,

FIG. 11 is a partial cross-sectional view of a spring assembly when compressed until stopping element or means limits the compression, and

FIG. 12 is a side view of a spring arrangement in accordance with example embodiments, where two spring assemblies are mounted on each other.

### DETAILED DESCRIPTION OF EXAMPLE EMBODIMENTS

Example embodiments described below are particularly applicable to a railway carriage or other types of vehicles, but may also be used as a low frequency mount for marine or industrial equipment (for instance suspension of machinery).

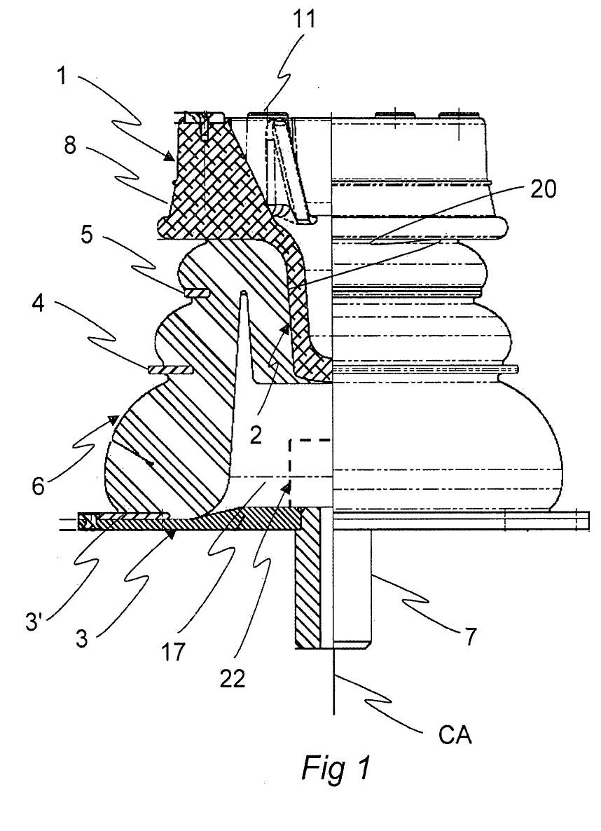

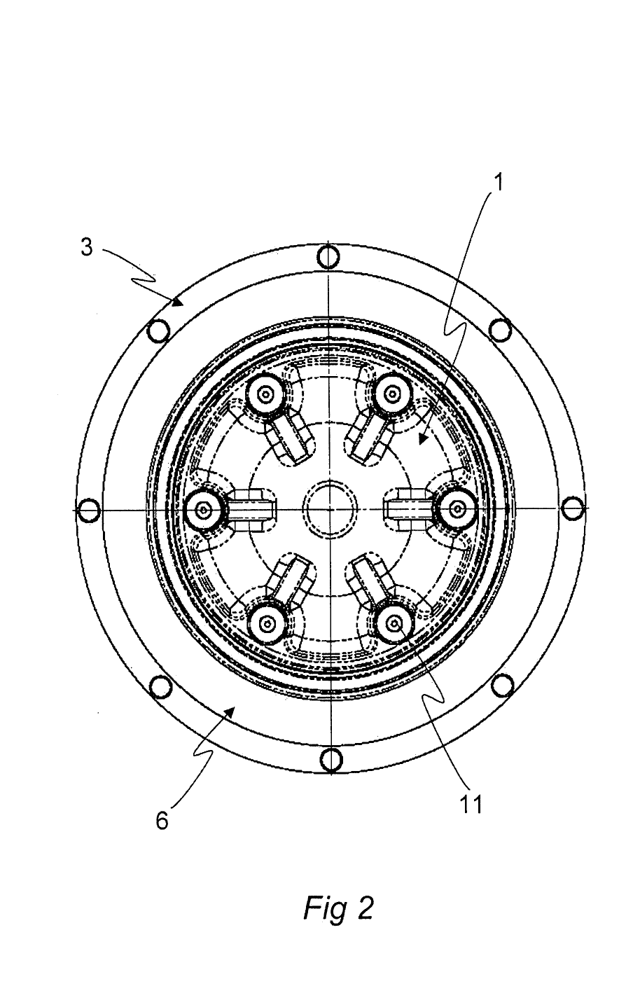

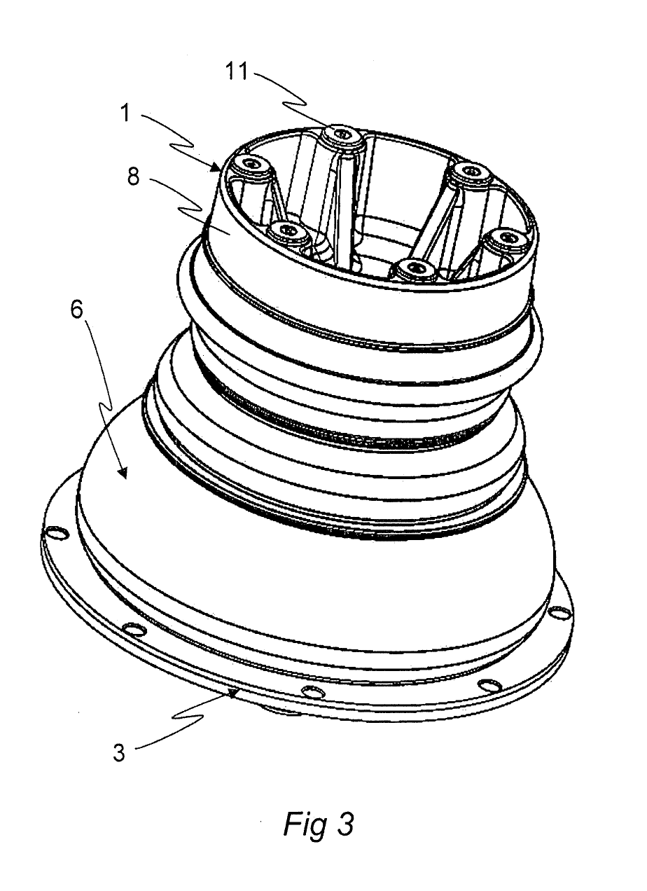

With reference to FIGS. 1-3, an elastomeric spring assembly according to example embodiments includes a first rigid end member 1 having stopping element or means with a central protuberance 2, and a second rigid end member 3. Two re-inforcing interleaf elements 4, 5 which may be made of metal, are embedded into an elastomeric member or body 6 consisting of a matrix of elastomeric material.

The central protuberance 2 can also be used in combination with a second central protuberance 22 (shown in phantom) which then also limits compression of the elastomeric body 6. The second central protuberance 22 can also be used solitarily without the central protuberance 2 to limit the compression.

The elastomeric body 6 is shaped in such a way that it provides a non-linear vertical stiffness, and it can be made of various elastomeric materials, such as a synthetic version of natural rubber, natural rubber or another elastomeric material, like polyisoprene. In example embodiments, the elastomeric body 6 is bonded to the first and the second end members 1, 3. In example embodiments, the entire interface between the upper end member 1 and the elastomeric body 6 is bonded. At its bottom the elastomeric body 6 is bonded to an annular element 3′ mounted to the lower end member 3. The bonding may be accomplished by vulcanization, but alternatively cold-bonding can be applied using an adhesive.

The elastomeric body 6 comprises a lower internal cavity 17 which opens towards the second end member 3. Further, the elastomeric body 6 comprises an upper internal cavity 20 in which the central protuberance 2 is located and bonded.

In order to achieve the aimed-at spring effect, the two interleaving elements 4, 5 are substantially rigid and embedded into the elastomeric body 6. It should be noted that embodiments with a number of interleaving elements 4, 5 are feasible within the scope of example embodiments. The interleaving elements 4, 5 are annular and continuous and they reinforce the elastomeric body 6 during compression and restrict the diameter of the elastomeric body 6 to increase during compression.

The lower end member 3 has a shaped profile defining vertical and horizontal characteristics, and it also has a boss or spigot 7 to provide a solid horizontal location where the spring assembly is installed.

As can be seen from the drawings, the spring assembly is symmetric about a centre axis CA.

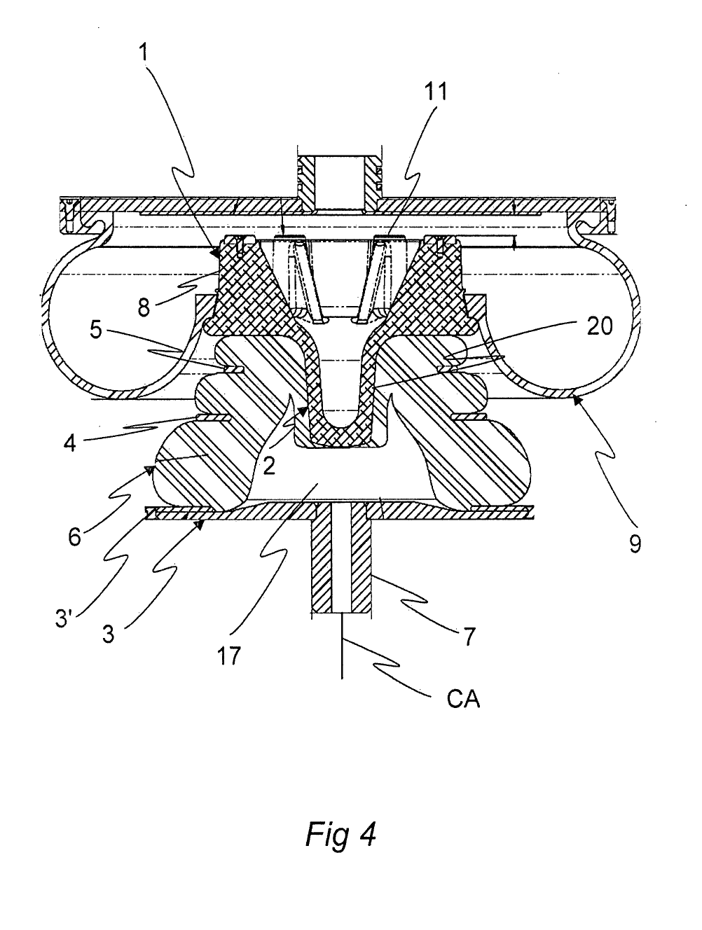

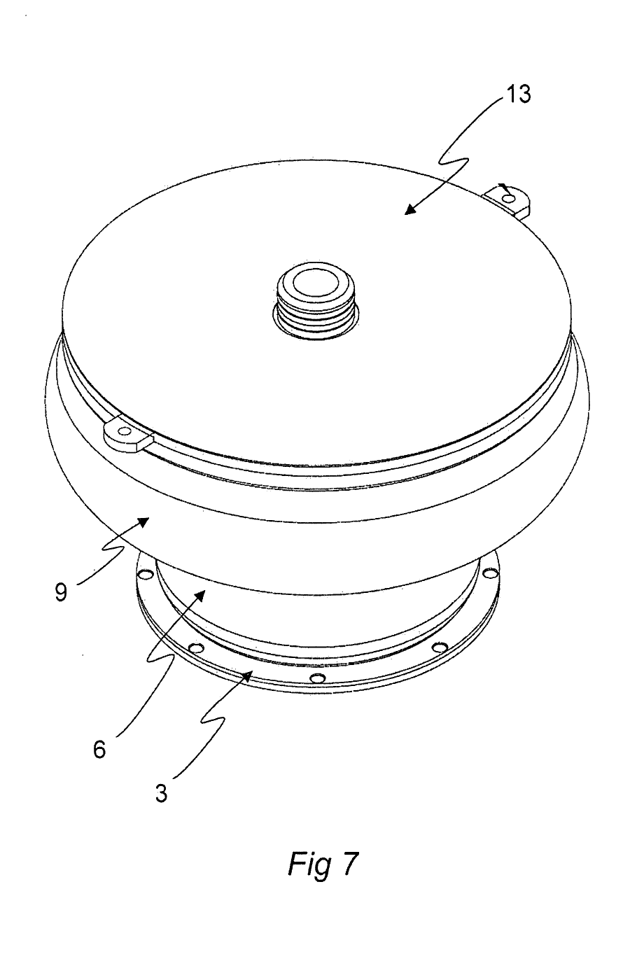

In example embodiments (see FIGS. 4 and 7), the upper end member 1 provides an annular sealing area 8 for fitting of an annular air bellow unit 9 which is air tight. The frustoconical shape of the elastomeric body 6 facilitates the use of the spring assembly in combination with the air bellow unit 9. The upper end member 1 has seats where low friction pads 11 may be fitted. These low friction pads 11 provide a sliding surface to accommodate horizontal movement in the event of air failure in the air bellow unit 9. By this structure, the vertical and horizontal compliance of the spring assembly is increased thus providing a level of compliance in the event of air failure.

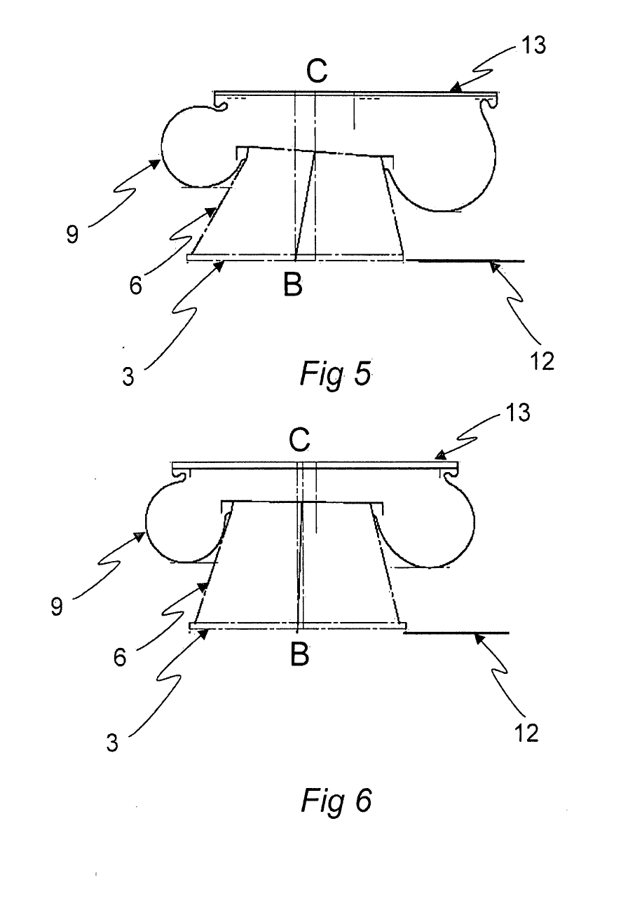

FIGS. 5-6 illustrate how the elastomeric spring assembly, in combination with an air bellow unit 9, behaves under different horizontal load conditions. The elastomeric body 6 allows horizontal deflection in addition to the horizontal deflection of the air bellow unit 9. The air bellow unit 9 compensates the deflection and allows mounting surfaces 12 and 13 to remain substantially parallel to each other. In this example, the upper mounting surface 13 is mounted, for instance, to a railway carriage C whereas the lower mounting surface 12 is mounted to a railway bogie B.

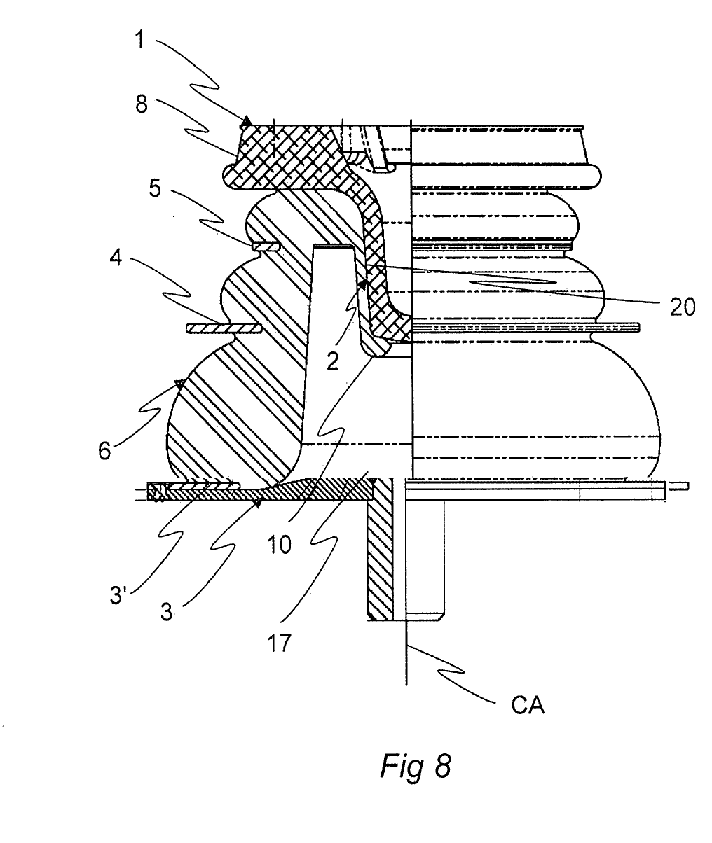

In the embodiment shown in FIG. 8, the upper portion of the first end member 1 is altered and made thinner than in the embodiment of FIG. 1. The fact that the first end member 1 is made thinner in this portion means that the sealing area 8 for the air bellow unit 9 is smaller, which gives the air bellow unit 9 more clearance before the upper side of the first end member 1 touches the mounting surface above. There is an increase in thickness for each layer of the elastomeric body 6 progressing down the same from end member 1 towards end member 3. Similarly the diameter of the elastomeric body 6 also increases.

The stopping element or means 2 of the upper end member 1 connects to an annular projection 10 of the elastomeric body 6 in order to alter the characteristics of the stopping element or means 2. By adding different thicknesses and shapes of the projection 10, the compression limitation can be tuned accurately to fit the application. In addition, the shape of the elastomeric body 6 is also altered relative to that of FIGS. 1-3; this is a way to change the characteristics of the elastomeric spring assembly. The size and shape of the interleaving elements 4, 5 are also altered relative to that of FIGS. 1-3, which changes the characteristics of the elastomeric spring assembly.

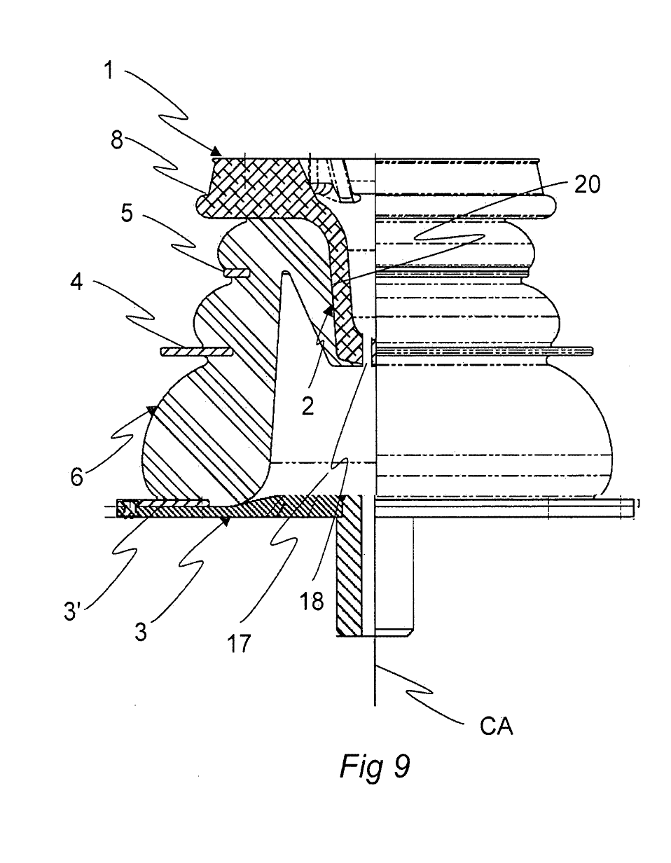

With reference to FIG. 9, it can be seen that the shape of the elastomeric body 6 is altered relative to that of FIG. 8. The elastomeric body 6 is differently shaped in order to achieve different characteristics. The elastomeric spring assembly further comprises an air through-passage 18 for supplying an air bellow (not shown in FIG. 9) with air through the internal cavity 17 of the elastomeric spring assembly. Such an air through passage 18 can be used in different embodiments of the elastomeric spring assembly whenever air is to be fed through the elastomeric spring assembly to for example an air bellow.

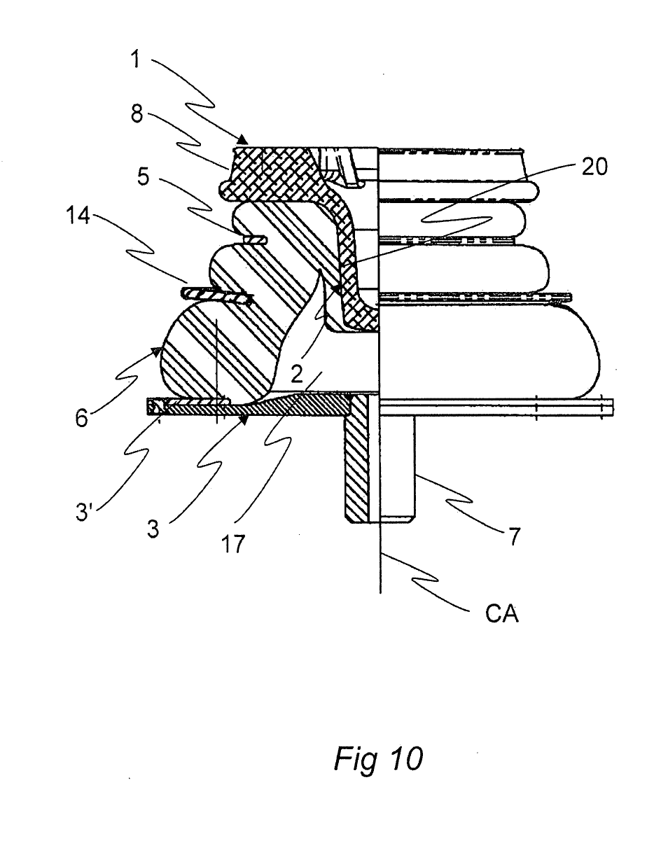

FIG. 10 shows an elastomeric spring assembly according to example embodiments including a conical interleaving element 14. The use of a conical interleaving element 14 is not restricted to this, but can be used in combination with different elastomeric bodies 6. In a variant (not shown), all interleaving elements are conical. The conical feature enhances fatigue endurance of the interleaving elements and the elastomeric body, and provides alternative vertical and horizontal stiffness characteristics as well.

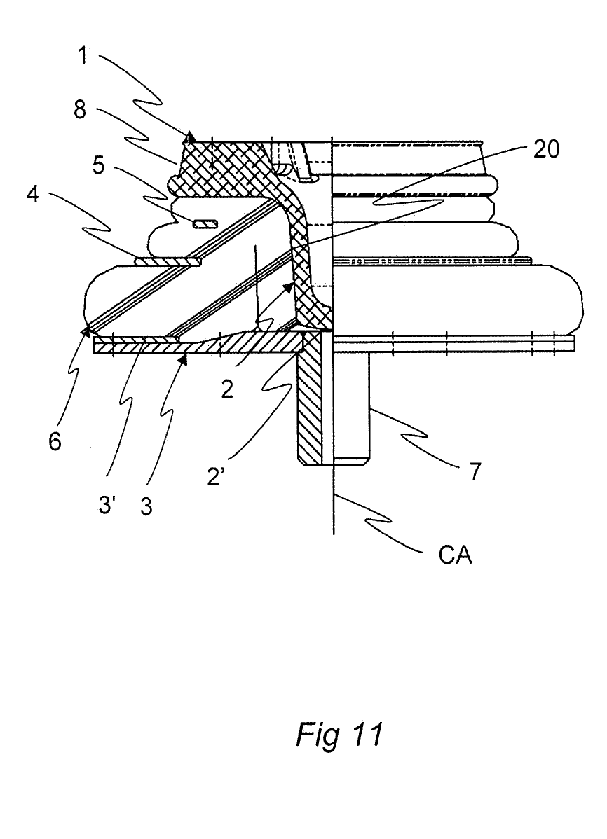

In FIG. 11 the elastomeric spring assembly is shown in its compressed state where the end portion 2′ of the central protuberance 2 is in contact with the second end member 3. In this position, the compression is limited and no further compression of the elastomeric spring assembly is possible.

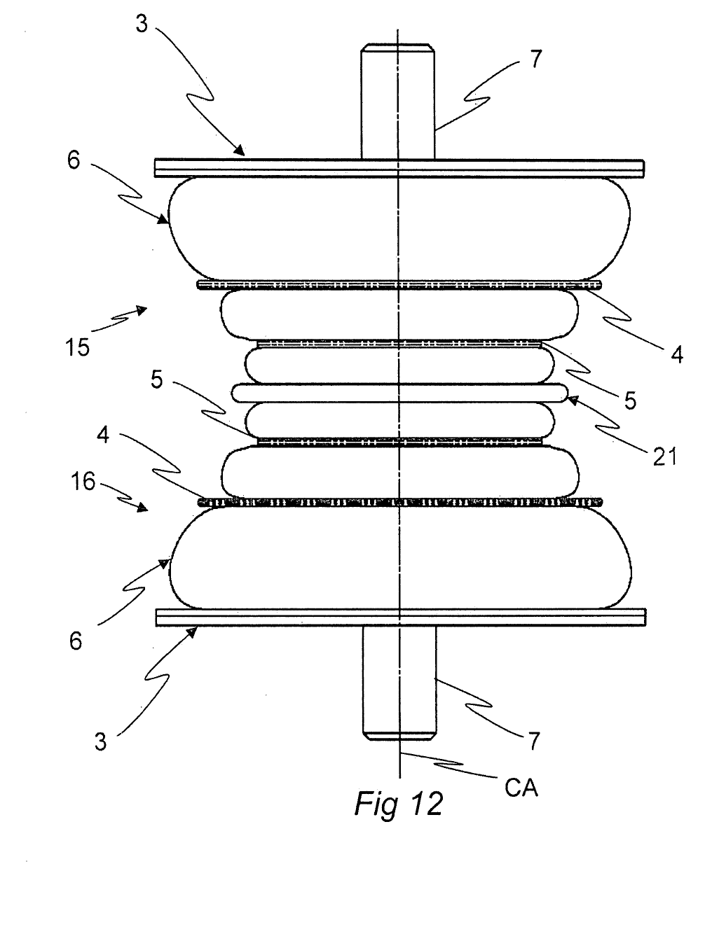

As shown in FIG. 12 a first spring assembly 15 is mounted on a second spring assembly 16, the two elastomeric bodies 6 forming an hourglass-formed shape. The spring assemblies 15, 16 are connected by an intermediate connecting member 21 which replaces the first end members of the spring assemblies 15, 16, respectively. Both elastomeric spring assemblies 15, 16 then work as a unit, providing a softer spring with a longer stroke.

Finally it should be mentioned that example embodiments are not restricted to those described herein, and several modifications are feasible within the scope of the appended claims. For instance, various structures of the interleaving element or means can be used. Furthermore, different types of air bellows can be used in combination with the spring assembly.

1. A spring assembly comprising:
a first end member;
a second end member spaced from said first end member;
an elastomeric body arranged between said first end member and said second end member, said elastomeric body being configured to be compressed in a main load direction which coincides with a centre axis of said spring assembly, said elastomeric body comprising an internal cavity which is symmetric about said centre axis and extends at least partially between said first end member and said second end member, said elastomeric body further comprising interleaving element; and
stopping element configured to mechanically limit compression of said elastomeric body in said main load direction.

2. The spring assembly of claim 1, wherein said stopping element comprises a protuberance which projects from said first end member and is located within said elastomeric body.

3. The spring assembly of claim 1, wherein said stopping element comprises a protuberance which projects from said second end member and is located within said internal cavity.

4. The spring assembly of claim 1, wherein said stopping element comprises a first protuberance which projects from said first end member and is located within said elastomeric body, and a second protuberance which projects from said second end member and is located within said internal cavity.

5. The spring assembly of claim 1, wherein said stopping element is at least partially enclosed by elastomeric material of said elastomeric body.

6. The spring assembly of claim 1, wherein said interleaving element comprises at least two annular interleaving elements which are concentrically arranged about said centre axis in axially spaced positions.

7. The spring assembly of claim 6, wherein said interleaving elements are made of substantially rigid material.

8. The spring assembly of claim 6, wherein at least one of said interleaving elements has a conical cross-section.

9. The spring assembly of claim 6, wherein said interleaving elements are at least partially embedded in said elastomeric body.

10. The spring assembly of claim 1, wherein said elastomeric body has a cross section which is symmetric about said centre axis.

11. The spring assembly of claim 1, wherein said elastomeric body has a general frustoconical cross-section.

12. The spring assembly of claim 1, wherein said elastomeric body consists of rubber.

13. The spring assembly of claim 1, wherein said internal cavity of said elastomeric body opens towards said second end member.

14. The spring assembly of claim 1, wherein said elastomeric body is bonded to said end members.

15. The spring assembly of claim 14, wherein said elastomeric body is bonded to said end members by vulcanization.

16. The spring assembly of claim 14, wherein said elastomeric body is cold-bonded to said end members by an adhesive.

17. The spring assembly of claim 1, further comprising air bellow element configured to be compressed in at least said main load direction.

18. The spring assembly of claim 17, wherein said air bellow element is attached to one of said end members.

19. The spring assembly of claim 17, wherein said one of said end members supporting said air bellow element is provided with a circumferential sealing area for an annular bellow of said air bellow element.

20. The spring assembly of claim 1, wherein one of said end members is provided with an air through-passage.

21. A spring arrangement comprising two spring assemblies as claimed in claim 1 which form a spring unit.

22. A suspension system comprising a number of spring assemblies as claimed in claim 1.

23. A vibration absorbing anti-shock mounting system comprising a number of spring assemblies as claimed in claim 1.

24. A wheeled vehicle comprising a number of spring assemblies as claimed in claim 1.

25. The vehicle of claim 24 being a railway carriage.
